(19) United States
(12) Patent Application Publication
(10) Pub. No.: US 2021/0368909 A1
(43) Pub. Date: Dec. 2, 2021

(54) ANTIMICROBIAL SHOE SOLES AND SHOE COVERINGS

(71) Applicant: Stonehouse Innovcations, LLC, Jackson, WI (US)

(72) Inventor: Anne Wick, Cederburg, WI (US)

(21) Appl. No.: 17/332,301

(22) Filed: May 27, 2021

Related U.S. Application Data
(60) Provisional application No. 63/032,993, filed on Jun. 1, 2020.
(60) Provisional application No. 63/076,714, filed on Sep. 10, 2020.

(51) Int. Cl. A43B 7/00; B60B 33/00

(52) U.S. Cl. CPC A43B 7/00; B60B 33/0039; B60B 33/0049

(57) ABSTRACT

Wheels, tires, wheel coverings, foot coverings and method for forming a wheel and/or foot covering that is defined by a body that is shaped to extend along the floor contacting surface under the wheel and/or sole of a foot of a wearer and includes an antimicrobial agent that is incorporated into the body and inseparable therefrom. The antimicrobial agent is selected and supported by the body of the wheel, wheel assembly, wheel covering, and/or foot covering to render microbial matter contacted by the body nonviable.

### CROSS-REFERENCE TO RELATED PATENTS

This application claims priority to U.S. Provisional Patent Application Ser. No. 63/032,993 filed on Jun. 1, 2020 titled “Antimicrobial Shoe Soles and Shoe Coverings” and U.S. Provisional Patent Application Ser. No. 63/076,714 filed on Sep. 10, 2020 titled “Antimicrobial Shoe Soles and Shoe Coverings” the disclosures of both of which are expressly incorporated herein.

### FIELD OF THE INVENTION

The present invention is directed to mitigating the transfer of viable biologic matter, such as viral and bacterial matter, from one location to another. The present invention is directed to footwear; such as sandals, flip-flips, shoes, boots, etc.; footwear coverings, such as removeable or disposable shoe covers or the like, and translatable support structures, such as wheels, casters, and the like, that are constructed to mitigate the transfer of viable microbial organisms or microorganisms, such as bacteria and viruses, between environments.

### BACKGROUND OF THE INVENTION

Floor surfaces, such as those found in care facilities and hospitals, can become contaminated with large numbers of microbial organisms such as bacteria and/or viruses such as MRSA, Staph, C-Diff, Covid, for example, and variants and strains thereof, every day. Various sources report that daily disinfection contributes little to nothing to the microbial cleanliness of facility or ward floors. Additionally, even when recently cleaned, newly cleaned floors become rapidly re-contaminated from microorganisms that can be transferred from patients, equipment, and personnel.

Once contaminated, transmission of these pathogens from room to room, work station to work station, cubicle to cubicle in emergency rooms, surgery suites, intensive care units (ICU's), etc. can be conveniently transmitted away from origin locations on the shoes or footwear of medical personnel, visitors, staff, and ancillary support personnel such as security agents, cleaning personnel etc. Physical transport of the microbial pathogens contributes considerably to cross contamination creating an increased risk for potential nosocorniai or health care associated infection (HCAI). Floors are commonly discussed as an underappreciated reservoir for pathogen transmission.

It is furthermore conceivable that due to the existence of microbiological pathogens on shoe soles, that the rapid spread of these organisms in the healthcare environment can be directly related to the presence of organisms on floors getting picked up and carried by shoe soles and transferred to floors in other areas of a facility at well as locations extraneous to the healthcare environments. Although various efforts have been made to mitigate transmission of pathogens beyond facility confines or origin locations via physical transport upon the shoes or footwear of persons working or passing therethrough, such efforts are commonly shown empirically to provide little efficacy.

One such approach relies on the providing of shoe coverings to facility staff and visitors. Even when provided in a reusable or washable methodology, such approaches act to mitigate the transmission of pathogens to the underlying foot covering of the wearer but such approaches do not mitigate the transmission of the pathogens throughout the environment in which the foot coverings are worn. That is, current shoe coverings protect the wearer from acquiring microbial bio matter on their footwear, but do not mitigate against the transmission of the microbial activity from the bottom or sole of shoe or shoe covering. That is, as soon as personnel touch the floor with shoes (covered or non-covered), microbial matter on the floor is transported through corridors and from room to room along the travel path of the wearer. Literature on the subject includes various empirical examples of cross contamination of microbial matter being transported in a viable form between environments.

Such transmission further complicates patient medical treatment objectives. Staff or personnel travelling room to room transport the microbial biologic matter therebetween and risk exposure of patients and visitors in one room to the microbial matter acquired in other locations. It has been shown to be problematic that patients walking in their rooms or within the hallways of medical facilities, commonly only in socked or bare feet and with or without assistance, acquire the pathogens on their slipper socks or bare feet. Returning to their room or beds with contaminated soles results in contamination of the quarters associated with their stay as well as their clothing and bed linens. Touching of the contaminated linens by the patient or their visitors with their hands and then using those hands to touch their food and eat it, or touch their eyes, or inside their nostrils, substantially increases the risk of infection acquisition.

Accordingly, there is a need for transport structures such as wheels or the like as well as foot and/or shoe coverings that adversely affect and preferably destroy the viability of microbial organism that come in contact with the respective wheel and/or foot and/or shoe coverings.

### SUMMARY OF THE INVENTION

A first aspect of the present invention discloses a foot covering that resolves one or more of the shortcomings disclosed above. One aspect of the present application discloses a foot covering and method for forming a foot covering that destroys the viability of at least a portion of biologic pathogens that come in contact with the foot covering. The foot covering is defined by a body that is shaped to extend under the sole of a foot or footwear of a wearer and includes an antimicrobial agent that is incorporated into the body and inseparable therefrom. The antimicrobial agent is selected and supported by the body of the foot covering to render microbial matter contacted by the body nonviable.

Another aspect of the present application that is combinable or useable with one or more of the aspects or features disclosed above includes a foot covering that is defined by a body having a foot facing surface and a floor facing surface. An antimicrobial material is incorporated into the body and operable to terminate the viability of microbial matter.

A further aspect of the present application that is useable or combinable with one or more of the aspects and features disclosed above discloses a method of forming a foot covering. A body is formed to extend continuously under a foot, whether shoed or bare. An antimicrobial agent is incorporated into the body and inseparable therefrom and is operable to exsanguinate the viability of at least a portion of the microbial matter that comes in contact with the body of the foot covering.

Another aspect of the present application discloses a wheel, such as a caster or the like suitable for use with medical equipment such as gurneys, meters, scopes, instrument carts, etc., that includes a floor contacting surface that includes antimicrobial properties. In one aspect, the wheel includes a tire portion that is constructed of the antimicrobial material as disclosed further below. In a further aspect of the present application, the antimicrobial structure associated with the wheel is provided as a low-profile tire or an energy responsive tape or wrap that can be disposed about an existing wheel assembly and, when applied thereabout, demonstrates antimicrobial viability performance when secured about a respective wheel and/or tire thereof.

These and other aspects, features, and advantages of the present invention will become apparent from the following detailed description, claims, and accompanying drawings.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a side elevation view of an exemplary shoe constructed in accordance with the present invention;

FIGS. 2A and 2B are perspective views of foot or shoe covers constructed in accordance with the present invention;

FIG. 3 is a perspective view of a wheel or wheel assembly constructed in accordance with another aspect of the present application;

FIG. 4 is a perspective view of an energy responsive wheel cover constructed in accordance with another aspect of the present application; and

FIG. 5 is a partial cross section perspective view of a wheel assembly or caster wheel constructed in accordance with the present application.

### DETAILED DESCRIPTION

In describing the preferred embodiments of the invention which are illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. The various features and advantageous details of the subject matter disclosed herein are explained more fully with reference to the non-limiting embodiments described in detail in the following description.

FIG. 1 is a side elevation view of a foot covering or shoe 10 constructed in accordance with the present invention. Although foot covering 10 is shown in a form factor commonly referred to as a shoe or tennis shoe, it is appreciated that foot covering 10 may be provided in various form factors such as boots, sandals, flip flops, substantially rubber or other waterproof material bodied foot wear, etc. to name but a few. That being said, it is appreciated that shoe 10 may be provided in virtually any form factor of a body constructed to be worn upon a foot of a wearer. It is also appreciated that, regardless of the form factor, shoe 10 is commonly provided in matching pairs of a left foot shoe and a right foot shoe that are generally mirror images of one another.

As shown in FIG. 1, shoe 10 is generally defined by a sole 12 having an upper 14 connected thereto. Sole 12 and upper 14 are generally extend between a toe portion 16 and a heel portion 18 that are oriented at generally opposite longitudinal ends of shoe 10. An opening 20 is generally defined by upper 14 and is shaped to accommodate the passage of the user's foot therethrough. In many embodiments, a tongue 22 extends from a location proximate toe portion 16 toward opening 20 and generally along a selectively tensionable closure mechanism 24. The closure mechanism 24, such as a lace or hook and loop closure or the like, is commonly provided to allow tensioning of the opposing lateral sides of upper 14 about the foot of a wearer.

Sole 12 generally includes one or more ridges 28 or traction features 30 that are formed along at least a portion of the longitudinal length thereof and constructed to provide a desired degree of traction relative to an underlying floor surface 32. Upper 14 can be constructed of various materials such as leather, pleather, rubber, silicone, polyurethane or like to provide a desired degree of ventilation, water resistance, flexibility, and rigidity thereto. It should be appreciated that, depending upon the preferences of the user, each of the respective comfort considerations discussed above can be provided in various relative degrees to satisfy the discrete demands or preferences of discrete users.

Regardless of the form factor in which shoe 10 is provided, sole 12, or at least an exterior surface thereof 50, is preferably formed of one or more of a rubber, silicone, and/or a polyurethane lightweight material, or a mixture thereof, and an antimicrobial agent that extends along at least a floor contacting surface defined by sole 12. Exterior surface 50 is defined by a body of a homogeneous material that includes an antimicrobial agent incorporated therein. When fully incorporated therein, the antimicrobial homogeneous agent material associated with at least surface 50 of sole 12 are temperature and moisture stable and do not adversely affect the frictional performance and customary rigidity associated with sole 12 when engaged with surfaces such as floor 32. The homogeneous nature associated with exterior surface 50 can extend entirely through sole 12 toward the interior surface of shoe 10 and is homogeneous throughout the thickness thereof such that the antimicrobial agent remains active and operable to render microbial matter no longer viable upon coming into contact therewith. Preferably, the antimicrobial agent is selected and integrated into the homogenous construction of sole 12 to require minimal dwell time associated with contact between exterior surface 50 and microbial agents engaged therewith so as to destroy the viability of microbial material that comes into contact shoe 10. As such, as shoe 10 travels throughout areas traversed by the wearer, shoe 10 acts to destroy the viability of microbial matter that comes in contact with exterior surface 50 as well as antimicrobial material that remains on floor 32 thereafter.

Although exterior surface 50 of shoe 10 is shown as extending in a principally downward oriented direction relative to shoe 10, is appreciated that exterior surface 50, and the homogeneous antimicrobial agent associated therewith, can extend in an generally upward direction about respective portions of the side of shoe 10 as may be desired for both function and/or esthetics. That is, when provided in more of a rubberized open shoe construction, it is appreciated that the entirety of such a shoe 10 may being constructed of silicone and/or polyurethane antimicrobial materials from various degrees to the entirety of toe 16 to heal 18 and from sole 12 upward and about a portion of or the entire upper 14 of a show 10 constructed in such a manner Such considerations further mitigate transference of microbial matter imparted toward the upper surfaces of shoe 10 from being transferred should the upper surface of shoe 10 subsequently come into contact if previous viable microbial matter was contacted thereupon.

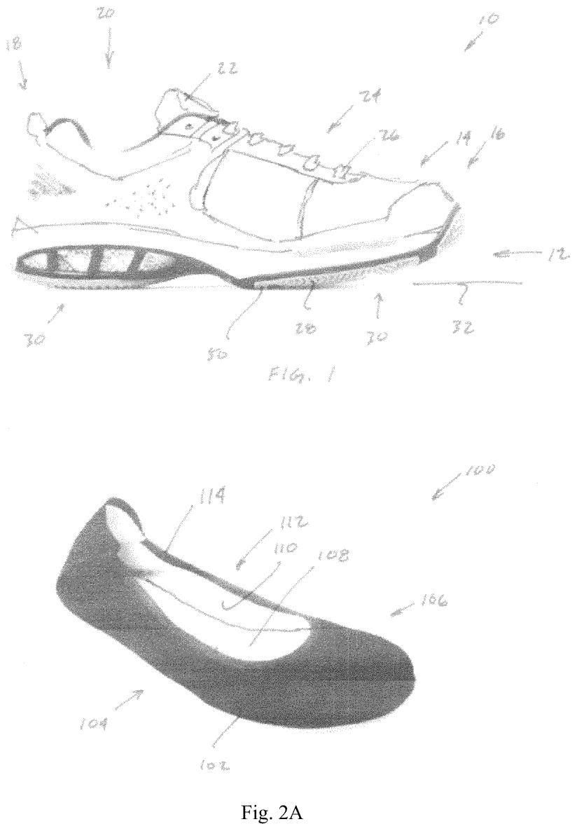

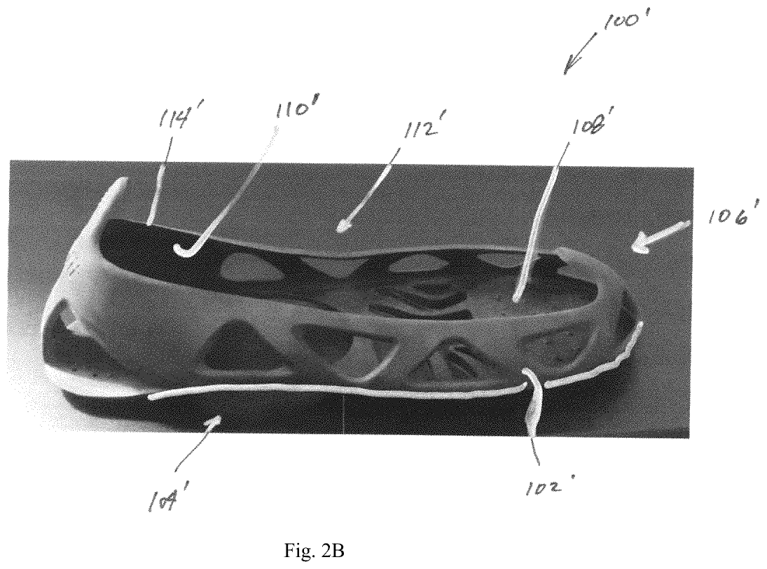

FIGS. 2A and 2B show respective embodiments of a foot or shoe cover 100, 100′ constructed in accordance with another embodiment of the invention. Covers 100, 100′ are defined by a body 102, 102′ that is generally provided in a more flexible form factor than shoe 10 and only loosely resembles footwear until engaged therewith. Once engaged with a foot or footwear such as shoe 10, cover 100, 100′ takes the shape thereof and limits exposure of the structure disposed therein to the environment. When engaged with a foot or shoe, body 102, 102′ of cover 100, 100′ generally defines the outward facing sole portion 104, 104′ and an upwardly directed upper portion 106, 106′. An upwardly directed surface 108, 108′ of sole 104, 104′ and an inwardly directed portion 110, 110′ of upper 106, 106′ are shaped to receive a foot or shoe of a wearer and to remain engaged therewith when so oriented until removed by the user. Although the inner and outer directed surfaces of soles 104, 104′ of covers 100, 100′ may be contoured to mitigate slippage between the outer surface and a floor and the inner surface and a sole of a shoe placed in the respective covering 100, 100′, soles 104, 104′ preferably provide a continuous unperforated surface within the area bounded by uppers 106, 106′ to mitigate contamination of footwear placed therein. It is further appreciated that although uppers 106′ is shown as including one or more optional perforations to encourage cooling of a foot associated therewith, it is further appreciated that uppers 106′ may also have a continuous uninterrupted or unperforated construction.

An opening 112, 112′ is generally defined by upper portion 106, 106′ of cover 100, 100′ and is shaped to accommodate slideable cooperation of a foot or shoe therewith. An upwardly directed portion of upper portion 106, 106′ is preferably bounded by a flexible member 114, 114; such as elastic or the like and/or a flexible construction thereof; and is shaped to secure cover 100, 100′ about a foot or shoe disposed therein. It should be appreciated that cover 100, 100′ can be provided in various sizes and may be provided in a ambidextrous form factor or a form factor associated with designate left and right anatomy of the user.

At least sole portion 104, 104′ and preferably the entirety of cover 100, 100′ aside from elastic member 114, 114′ is constructed of a homogeneous material comprised of a mixture of one or more of silicone and/or polyurethane material and an antimicrobial agent homogeneously incorporated therein during formation of cover 100, 100′. Like shoe 10, shoe cover 100, 100′ is constructed to mitigate the transference of viable microbial matter between environments. Like sole 50 of shoe 10, body 102, 102′ of cover 100, 100′ is constructed of a flexible or otherwise pliable member that does not unduly adversely affect the user's anticipated traction performance and in a manner which is constructed of a continuous homogeneous material of silicone or polyurethane and/or mixtures thereof, and an antimicrobial agent integrated therewith and which is operable to destroy the viability of microorganisms coming into contact therewith. Preferably, each of cover 100, 100′ are constructed to as to be stretchable to allow the discrete covers 100, 100′ to be engaged with shoes of user's having various foot sizes.

Each of shoe 10 and cover 100, 100′ provide a flexible, reusable, non-slip antimicrobial foot covering that eliminates and/or mitigates viability of microbial matter, such as bacteria and viruses, found in various environments and can be common to floors or other surfaces. Each of shoe 10 and cover 100, 100′ are constructed to prevent cross contamination associated with the soles of shoes or the footwear of medical personnel traveling from room to room, station to station, in various environments including long-term care settings, healthcare settings, food preparation, veterinarians, meatpacking and food packing industries etc. Under the category of personal protective equipment (PPE), shoe 10 and covers 100, 100′ can be used in the daily environment by medical personnel, ancillary staff, emergency rooms, operating rooms, intensive care units, etc. various other environments such as food preparation and meatpacking environments, where infection and/or cross-contamination of surfaces associated therewith is intended for the desired sanitary treatment of personnel and materials handled therein.

When applied in a medical environment, shoe 10 and covers 100, 100′ mitigate the risk associated with nosocomial infection. As disclosed above, each of shoe 10 and cover 100, 100′ are constructed or include a sole portion that includes an antimicrobial material embedded in a homogenous manner throughout the substance of at least the sole portion thereof. Antimicrobial substances incorporated into shoe 10 and/or cover 100, 100′ are preferably constructed and selected to kill microbial matter, such as bacteria and viruses, upon contact therewith. When deployed, each of shoe 10 and covers 100, 100′ significantly reduce the transmission of pathogens that are commonly found on the bottoms of shoes as well as current types of disposable shoe coverings when deployed in various environments and across various industries. At least the sole of shoe 10 and the sole portion of covers 100, 100′ are preferably constructed of a generally homogeneous material that includes an antimicrobial reactant contained therein.

Shoe 10 and covers 100, 100′ provide a nonslip/non-skid surface that preferably includes one or more ridges or contours associated with providing a desired degree of traction engagement for the user with an underlying floor surface. Covers 100, 100′ are preferably configured to fit snugly over soles of shoes and around the heel and respective toe portions thereof to maintain the desired operational association of the respective cover 100 with the underlying foot or shoe.

Preferably, the antimicrobial agent associated with shoe 10 and covers 100, 100′ are configured in a homogeneous orientation relative to the thickness of at least the sole of the respective shoe 10 or shoe covering 100, 100′ so as to maintain the desired efficacy of the sole to terminate microbial matter throughout the usable life thereof. The reusable and cleanable nature of each of shoes 10 and covers 100, 100′ reduces facility as well as user costs by reducing hazardous waste disposal and incineration costs as well as reducing waste generated associated with disposal and/or replacement of other commercially available single use shoe covers. The reusability of shoe 10 and foot coverings 100, 100′ further mitigate facility costs by reducing patient and visitor single use personal protective equipment supply costs. Preferably, each of shoe 10 and/or covers 100, 100′ are constructed to be rinsed and/or hand or machine washed after use and economically replaceable should the tread pattern of a respective shoe 10 or cover 100, 100′ become thin or should the body of foot cover 100, 100′ become torn. Additionally, it is further appreciated that each of shoe 10 or cover 100, 100′ may be laundered in conjunction with a disinfection system to further enhance the reusability and maintenance of the sanitary condition thereof.

Each of shoe 10 and covering 100, 100′ present various advantages over known systems associated with mitigation of foot traffic cross-contamination in various environments and industries. That is, as the wearers traverse the respective floor surfaces and environments wearing shoes 10 and/or covers 100, 100′, the areas traversed are both decontaminated and transference of viable microbial matter is mitigated thereby mitigating the transference of pathogens from room to room, station to station, environment to environment, and personnel to personnel and/or other structures. Although disclosed above as being applicable to shoes and foot or foot wear coverings, it is appreciated that the homogenous robust antibacterial material of the body of soles of shoes 10 and/or covers 100, 100′ as disclosed above may be incorporated into other structures, such as wheels or tires, or covering suitable for use with such wheels or tires as disclosed further below, of equipment and/or carts commonly employed in such environments.

FIG. 3 shows one such castor or wheel assembly 130 constructed in accordance with the present invention. Wheel assembly 130 includes a frame 132 that is secured to a leg 134 of an overlying piece of equipment. Frame 132 may be positionally fixed relative to a base 136 or rotatable relative thereto via a stem 137 extending therebetween. Frame 132 supports an axle 138 associated with securing a wheel 140 relative thereto. A stopper break 142 may be supported by frame 132 and constructed to interact with wheel 140 so as to limit rotation thereof about axle 138 and/or rotation of frame 132 about stem 137. Wheel 140 is rotatable relative to axle 138 generally opposite rotational directions, indicated by arrow 144, relative to frame 132 and rotatable relative to base 136 about stem 137, as indicated by arrow 146.

Wheel 140 can be constructed as a generally uniform body and/or constructed to include a hub 152 generally associated with axle 138 and a tread or tire 154 positioned thereabout. Regardless of the relative construction, an outer radial surface 156 of wheel 140 is constructed to engage a ground or floor surface 158 during translation of wheel 140 relative thereto. At least in outer radial surface 156 of wheel 140 is constructed of a body 160 formed of a uniform and homogeneous material having antimicrobial properties as disclosed further above. When constructed to define a hub 152 and a tire 154, higher 154 defines body 160 having a uniform construction when formed of a homogeneous antimicrobial material. Such consideration accommodates the antimicrobial performance associated with mitigating transferring of viable biological material during motion of wheel assembly 130.

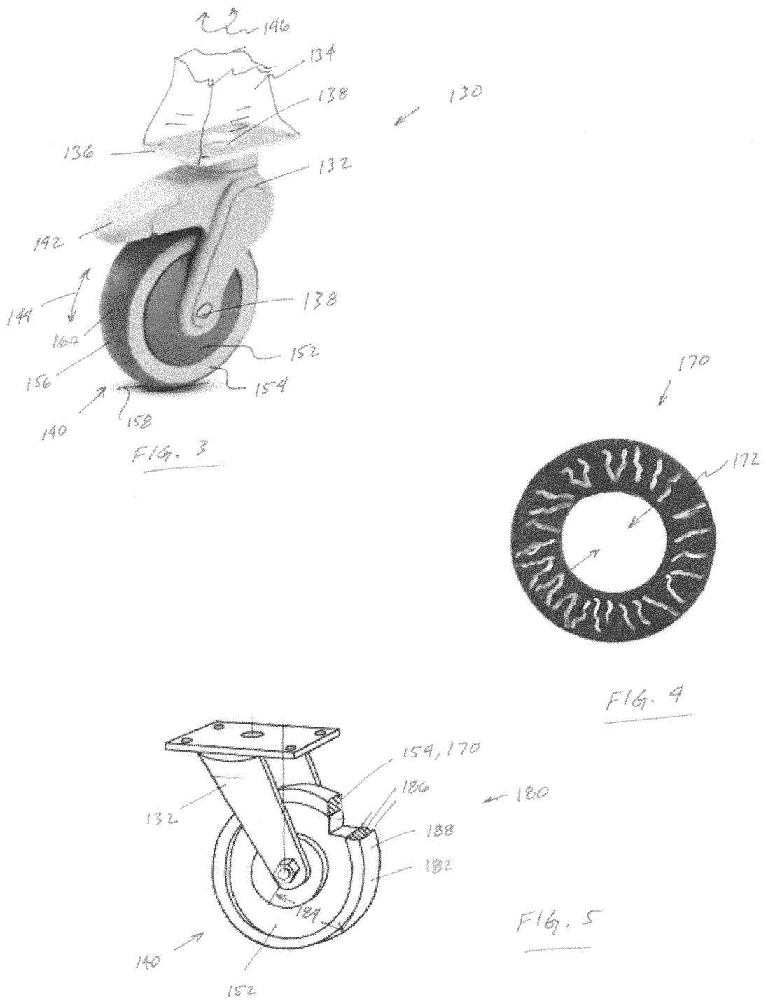

FIG. 4 shows an alternate embodiment of the present invention in the form of a wheel covering 170 constructed in accordance with the present invention. Covering 170 is defined by a body 172 that is formed of a homogeneous and antimicrobial material. Body 172 is further constructed to be energy responsive so as to reduce the cross-sectional shape and/or available outer radial dimension associated therewith. Subjecting covering 172 an energy signal such as a thermal and/or an infrared energy signal manipulates the shape of the material without detrimentally impacting the antimicrobial performance thereof and in a manner that allows the selective application and/or securing of covering 172 an underlying wheel or tire. In a preferred aspect, once placed about the outer circumference of an underlying wheel and subjected to the respective energy signal, covering 170 is secured/and/or permanently adhered about the outer surface of the underlying wheel. It is further appreciated, that covering 170 may be provided so as to be replaceable, interchangeable and or re-serviceable with subsequent coverings should the thickness and/or continuity of covering 170 be degraded after use thereof.

Referring to FIG. 5, whether provided as a tire 154, a covering 170 secured about a tire and/or wheel or hub, and/or a wheel or tire having a uniform cross-sectional composition, wheel 180 defines an outward radial surface 182 having a thickness, anywhere within a dimension, indicated by arrow 184, defined by a body 186 having uniform homogeneous construction and which has an antimicrobial performance such that at least an outer radial surface 188 thereof detrimentally affects the viability of microbial matter that comes into contact therewith and mitigates the transference of viable microbial matter. It should be appreciated, that a wheel 180 having a uniform composition from the radially outer edge to the radially inboard edge thereof can have an appreciably longer service life than a wheel 180 having a hub and tire Association and/or a wheel 180 equipped with cover 170. It should be appreciated that implementation of wheel covering 170 provides an economical and expedient alternative solution as compared to full replacement of discrete wheels 140, rotational wheel assemblies 130, and/or wheel assemblies that are already in service but do not provide mitigation of transference of viable microbial matter between environments when deployed. That is, service personnel, facilities, and wheel assembly providers can economically adapt current stock and/or currently deployed wheeled equipment to exhibit the antimicrobial performance as disclosed in the present application.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims. The present invention has been described in terms of the preferred embodiment, and it is recognized that equivalents, alternatives and modifications, aside from those expressly stated, are possible and within the scope of the appending claims.

What is claimed is:

1. A foot covering comprising:
a body having a foot facing surface and a floor facing surface; and
an antimicrobial material incorporated into the body and operable to terminate the viability of microbial matter.

2. The foot covering of claim 1 further comprising an elastic member engaged with a perimeter edge of the body and constructed to secure the body about at least a sole portion of a shoe.

3. The foot covering of claim 1 wherein the body is further defined as a sole of a shoe.

4. The foot covering of claim 3 further comprising an upper secured to a perimeter of the sole.

5. The foot covering of claim 3 further comprising a lace engaged with the upper.

6. A method of forming a foot covering comprising:
forming a body to extend continuously under a foot; and
integrating an antimicrobial agent into the body.

7. The method of claim 6 further comprising forming the body as a sole of a shoe and securing an upper about a perimeter of the shoe.

8. The method of claim 6 further comprising securing an elastic member to a perimeter of the body such that at least a sole portion of a shoe can be placed within the body and the body can be secured to the shoe via the elastic member.

9. A caster wheel assembly comprising:
a frame that defines at least one axle support;
an axle engaged with the at least one axle support; and
a wheel secured to the axle such that the wheel is rotatable thereabout and defined by a body that extends in an outward radial direction to an outer radial surface thereof and wherein at least the outer radial surface thereof includes an antimicrobial material incorporated therein.

10. The caster wheel assembly of claim 9 wherein the body of the wheel has a uniform composition throughout.

11. The caster wheel assembly of claim 9 wherein the wheel is further defined as a hub portion and a tread portion and the tread portion includes the antimicrobial material.

12. A wheel covering defined by a body that is formed of an antimicrobial material and that is responsive to exposure to an energy signal to reduce a shape of the body.

13. The wheel covering of claim 12 wherein the energy signal is thermal energy.

14. The wheel covering of claim 12 wherein the body is heat shrinkable.
